(19) United States
(12) Patent Application Publication
(10) Pub. No.: US 2025/0289743 A1
(43) Pub. Date: Sep. 18, 2025

(54) A WATER PURIFICATION SYSTEM AND A PROCESS THEREOF

(71) Applicant: HAVELLS INDIA LIMITED, New Delhi (IN)

(72) Inventor: Suresh Sisodia, Noida (IN)

(73) Assignee: HAVELLS INDIA LIMITED, New Delhi, DL (IN)

(21) Appl. No.: 18/862,348

(22) PCT Filed: May 4, 2023
(86) PCT No.: PCT/IN2023/050430

§ 371 Date: Nov. 1, 2024

(30) Foreign Application Priority Data
May 4, 2022 (IN) 202211025804
Oct. 17, 2022 (IN) 202211059284

(51) Int. Cl. C02F 9/00; B01D 61/46; C02F 1/00; C02F 1/28; C02F 1/32; C02F 1/469; C02F 1/66; C02F 1/68; C02F 101/12; C02F 101/30

(52) U.S. Cl. CPC C02F 9/00; B01D 61/463; C02F 1/008; B01D 2313/18; B01D 2313/345; B01D 2313/903; C02F 1/001; C02F 1/283; C02F 1/325; C02F 1/4693; C02F 1/66; C02F 1/68; C02F 2101/12; C02F 2101/306; C02F 2201/005; C02F 2201/006; C02F 2209/10; C02F 2209/40; C02F 2303/04

(57) ABSTRACT

The present invention provides a system (1) and a process for purification of fluids, particularly water, to get a constant or desired output quality of water irrespective of the variations in the input quality of water. The water purification system of the present invention employs a microcontroller designed to set purification parameters (current/voltage/etc.) or the desired quality of water that is needed, for working of the operative cell.

### FIELD OF INVENTION

The present invention relates to the field of water purification systems. In particular, a system comprising a dual cycle water purification system is described herein.

### BACKGROUND OF THE INVENTION

Particularly in developing countries, supply water is largely unfit for human consumption and needs to be purified. In fact, the supply water can also be unfit for household use. It is quite common in such countries, particularly in urban households, to employ one or more different technologies to treat water for various uses. Even in developed countries, where supply tap water is generally suitable for human consumption, there is still a need to ensure further purity.

RO water purification systems is a particular technology, which can be ubiquitously found in households in urban areas. However, there are various drawbacks to available RO water purification systems, particularly the amount of “discarded/waste” water which can be as high as 75%, pre-determined water purity levels, and energy consumption. Another drawback of RO systems is the removal of minerals from purified water, many of which are otherwise beneficial for human consumption in trace amounts.

Therefore, there remains a need for better and more efficient technologies and systems for water purification, which not only overcome some of the limitations in the art, but are also more environment friendly.

### SUMMARY OF THE INVENTION

In an aspect of the present invention, there is provided a water purification system comprising: at least a sensor, a cell comprising a plurality of selective ion exchange membranes located between at least two electrodes; at least a valve to control water flow; and at least a microcontroller to modulate at least the current or voltage in the cell electrodes.

In an aspect of the present invention, the system further comprise at least one of a sediment cartridge, activated carbon cartridge, a germicidal UV cartridge, and at least a mineral cartridge.

In an aspect of the present invention, at least a first sensor detects total dissolved solids in input water, and at least a second sensor detects total dissolved solids in permeate water.

In another aspect of the present invention, said at least a microcontroller modulates the input current or voltage of the cell electrodes.

In another aspect of the present invention, the said system employs dual cycle water purification comprising a first cycle and a second cycle.

In still another aspect of the present invention, the first cycle and second cycle run duration time can be same or different.

In an aspect of the present invention, the polarity of the electrodes in first cycle and second cycle are reversed.

In yet another aspect of the present invention, the cell comprise at least a cation exchange membrane and at least an anion exchange membrane.

In an aspect of the present invention, no two cation or anion exchange membranes are adjacent to each other.

In an aspect of the present invention, the system comprises a first input valve and a second input valve to direct input water into at least a first and second compartment respectively of the cell.

In an aspect of the present invention, the system comprises at least a flow controller, in particular, a first flow controller and a second flow controller.

In another aspect of the present invention, in the first cycle, for a time duration, the first flow controller directs upto 90% of input water through first input valve into at least a plurality of first compartments of the cell, and the second flow controller directs at least 10% of input water through second input valve into at least a plurality of second compartments of the cell; and in second cycle, for a time duration, the first flow controller directs upto 90% of input water through first input valve into at least the plurality of second compartments of the cell, and the second flow controller directs at least 10% of input water through second input valve into at least the plurality of first compartments of the cell.

In an aspect of the present invention, the system comprises at least a first output valve, and at least a second output valve.

In still another aspect of the present invention, said at least first output valve (6c) directs discard water in cycle 1 and collects permeate water in cycle 2; and second output valve (6d) collects permeate water in cycle 1 and directs discard water in cycle 2.

In an aspect of the present invention, the switching of first outlet valve (6c) in cycle 2 is delayed by a time period after initiation of cycle 2; and switching of second outlet valve (6d) is delayed for a time period after initiation of cycle 1 after cycle 2.

In an aspect of the present invention, the system is capable of maintaining output water purity parameters across a wide band of input water parameters.

In still another aspect of the present invention, the valves are solenoid valves.

In still another aspect of the present invention, the mineral cartridge optionally adds at least a mineral to the permeate water.

In another aspect of the present invention, there is provided a method of purifying water, said method comprising: selecting required parameters of purified water via a user interface of a system, said system comprising: at least a sensor, a cell comprising a plurality of selective ion exchange membranes located between at least two electrodes; at least a valve to control water flow; and at least a microcontroller to modulate at least the current or voltage in the cell electrodes; allowing input water to enter the system; and collecting purified water.

### BRIEF DESCRIPTION OF THE DRAWINGS

Advantages, features and uses of the invention will be clear from the following detailed description of non-limiting embodiments of the invention when considered in conjunction with the drawings, which are schematic and not to scale. For clarity, not every component is explicitly labeled or shown.

FIG. 1 is a schematic diagram illustrating the first cycle of the water purification system, in accordance with embodiments of the present invention.

FIG. 2 is a schematic diagram illustration the second cycle of the water purification system, in accordance with embodiments of the present invention.

### DETAILED DESCRIPTION OF THE INVENTION

This invention is not to be construed as limiting in its application to the details of the components and arrangement as set forth in the following description. The invention is capable of other embodiments and of being practiced or carried out in various ways. Terms and phrases used herein is for the purpose of description and should not be construed as limiting. To avoid detail not necessary to enable those skilled in the art to practice the invention, the description may omit certain information otherwise commonly known to those skilled in the art. The embodiments described herein are described in sufficient detail to enable those skilled in the art to practice the invention.

Total Dissolved Solids (TDS) refers to total organic and inorganic compounds dissolve in water. It includes, but may not be limited to presence of cations such as calcium, magnesium, arsenic, zinc, chromium, potassium; and anions such as sulfates, fluorides, carbonates, phosphates, and bicarbonates. TDS is measured in parts per million (PPM) or milligrams per liter (mg/L)

The present invention provides a water purification system comprising: at least a sensor, a cell comprising a plurality of selective ion exchange membranes located between at least two electrodes; at least a valve to control water flow; and at least a microcontroller to modulate at least the current or voltage in the cell electrodes.

In an embodiment, the water purification system further comprises a pre-filtration unit comprising at least one of a sediment cartridge, activated carbon cartridge, and a germicidal UV cartridge. In a preferred embodiment, the pre-filtration unit of the water purification system comprises a sediment cartridge, an activated carbon cartridge, and a germicidal UV cartridge. In one embodiment, the sediment cartridge directly receives water to be purified (input water) from a water source. In an embodiment, the activated carbon cartridge is downstream of the sediment cartridge and the germicidal UV cartridge is further downstream of the activated carbon cartridge. It is understood to a person skilled in the art that the particular arrangement of the cartridges described herein are not limiting in nature. Multiple cartridges can also be used arranged in any sequence in series. The pre-filtration system may also comprise only two cartridges, which can be combination of sediment cartridge and activated carbon cartridge; or sediment cartridge and germicidal UV cartridge; or activated carbon cartridge and germicidal UV cartridge.

Sediment cartridge removes coarse and fine suspended impurities such as sand, silt, dust, clay, and rust, etc. from the source/input water. It improves the performance and enhances the life of the downstream activated carbon cartridge and the cell.

Activated carbon cartridge removes a wide range of dissolved organic impurities such as pesticides, herbicides, and the like. It also removes impurities such as residual chlorine and its by-products. It also removes bad odor and organic impurities.

Mineral cartridge balances the pH level of purified water and fortifies the purified water by adding essential minerals, salts and trace elements such as calcium, magnesium potassium, sodium, copper, zinc, etc. It also help to lower the oxidation reduction potential (ORP) of the purified water resulting in anti-oxidant nature of water, which is generally healthier and tastier.

Germicidal UV cartridge has a UV C light source which disinfects the water to render it free from microbiological entities.

In an embodiment, the water purification system optionally comprises a post-filtration unit comprising at least a mineral cartridge. The mineral cartridge comprises one or more minerals safe and useful for human consumption. The mineral cartridge fortifies purified water by adding one or more minerals as per user requirement. In a preferred embodiment, the post filtration unit comprising a mineral cartridge is positioned downstream of the filtration unit.

In an embodiment, the water purification system comprises at least a first sensor capable of detecting total dissolved solids (TDS) in input water. The sensor capable of detecting TDS in input water can be a single sensor or a plurality of sensors. In an embodiment, the sensor is located between the water source and the sediment cartridge of the pre-filtration unit. In an embodiment, the water purification system comprises at least a second sensor capable of detecting TDS in purified water. The sensor capable of detecting TDS in purified water can be a single sensor or a plurality of sensors. In an embodiment, the sensor is located between the purified water storage tank and the mineral cartridge.

The filtration unit of the water purification system comprises a cell comprising a plurality of selective ion exchange membranes located between at least two electrodes. In an embodiment, the plurality of selective ion exchange membranes comprise at least a cation exchange membrane. In an embodiment, the plurality of selective ion exchange membranes comprise at least an anion exchange membrane. In a preferred embodiment, the plurality of selective ion exchange membranes comprise at least a cation exchange membrane and an anion exchange membrane. In an embodiment, the cell comprises an odd number of membranes. In an embodiment, the cell comprises an even number of membranes. In an embodiment, the number of cation exchange membranes are equal to the number of anion exchange membranes in the cell. In an embodiment, the number of cation exchange membranes is more that the number of anion exchange membranes in the cell. In an embodiment, the number of cation exchange membranes is less that the number of anion exchange membranes in the cell. In a preferred arrangement of the ion selective membranes in the cell, no two adjacent membranes are cation exchange membranes or anion exchange membranes. The number of membranes can vary as per requirement of the system, such as 2, 3, 4, 5, 6, 7, or more, and is not a limiting feature of the invention. The number of membranes can be based upon the particular use/application of the water purification system, such as rate (volume) of water purification. The spacer distance between any two membranes or between electrode and membrane may vary or may be pre-fixed based on particular requirements of the water purification system and is not to be considered as a limiting feature.

In an embodiment, the plurality of ion selective membranes are sandwiched between at least two electrodes. In an embodiment, the first electrode is a cathode and the second electrode is anode. In an embodiment, there can be multiple cathodes and anodes. In a preferred embodiment, the electrodes are made of carbon-based material. In a more preferred embodiment, the carbon-based material is graphite. In an embodiment, the electrodes can be metal based such as, but not limited to stainless steel, copper, nickel, gold, silver, platinum, etc. In an embodiment, the electrodes are capacitive electrodes.

The space between any two adjacent ion selective membranes or electrode(s) and adjacent membrane is a compartment. Each compartment comprises at least a water inlet and at least a water outlet.

The water purification system comprises a plurality of valves to control water flow in the water purification system. In an embodiment, the valves are essentially solenoid valves. Other kinds of valves are also possible, which can be substituted in place of solenoid valves. Without limiting the scope of the invention, in an embodiment, at least a valve of the system has a single input and a single output. In another embodiment, at least a valve of the system has a single input and dual output. In yet another embodiment, at least a valve of the system has a dual input and single output.

In an embodiment, the system comprises a first input valve and a second input valve to direct input water into at least a compartment of the cell of the purification unit. The amount of water flowing through the first input valve is controlled by a first flow controller. The amount of water flowing thought the second input valve is controlled by a second flow controller. In an embodiment, the first flow controller allows upto 90% of input water to flow through the first input valve. In an embodiment, the second flow controller allows at least 10% of input water to flow through the second input valve. In an embodiment, the first flow controller allows 90% of input water to flow through the first input valve and the second flow controller allows the remainder 10% of input water to flow through the second input valve. In another embodiment, the first flow controller allows 80% of input water to flow through the first input valve and the second flow controller allows the remainder 20% of input water to flow through the second input valve. Other percent amount of input water flowing through the first input valve and corresponding remainder percent amount of input water flowing through the second input valve are also contemplated to be part of this disclosure.

The purification unit of the water purification system comprising the cell employs a dual cycle purification comprising a first cycle and a second cycle. In the first cycle, at least a first electrode in the cell is designated as cathode based on power supply, while at least a second electrode in the cell is designated as anode based on power supply. In the second cycle, the polarity of the power supply is reversed such that the designated cathode in first cycle is now anode and the designated anode in first cycle is now cathode. In an embodiment, during the first cycle or second cycle, the voltage and/or current applied may be a fixed value, or auto selectable range of pre-determined values. The voltage and/or current applied to the electrodes of the cell is controlled by at least a microcontroller module. In an embodiment, the microcontroller module can be programmable. In an embodiment, the duration of first cycle and second cycle is fixed. In an embodiment, the duration of first cycle and second cycle can be auto selectable range of pre-determined values. The selection of duration of cycles is controlled by at least a microcontroller module. The microcontroller module can automatically select purification parameters based on input water TDS and desired TDS of output/purified water. The microcontroller module can also monitor in real-time the input water TDS levels and accordingly optimize purification parameters to maintain desired output/purified water TDS levels.

In an embodiment of the first cycle of water purification, 90% of input water is directed by the first input valve into at least a first compartment of the cell and 10% of input water is directed by the second input valve into at least a second compartment of the cell. The first and second compartment are adjacent to each other. In a preferred embodiment, the first input valve directs 90% of the input water into a plurality of designated first compartments, wherein no two adjacent compartments in the cell can be designed as first compartments; and the second input valve directs 10% of the input water into a plurality of designated second compartments, wherein no two adjacent compartments in the cell can be designated as second compartments. The designated first and second compartments repeat in an alternating manner. In an embodiment of the second cycle of water purification, 90% of input water is directed by the first input valve into the compartment(s) designated as second compartment(s) in the first cycle; and 10% of input water is directed by the second input valve into the compartment(s) designated as first compartment(s) in the first cycle. It is understood that other percent amounts of input water directed by the first input valve and second input valve are contemplated to be deemed disclosed as part of this specification.

In an embodiment, the duration of first cycle and second cycle of purification is pre-fixed. In an embodiment, the duration of first cycle and second cycle of purification is based on a plurality of prefixed auto selectable values. The duration of first cycle and second cycle can be based on input water TDS content. The duration of first cycle and second cycle can be based on required purified water TDS content.

The post-purification unit of the water purification system comprises at least a first output valve to direct discard water in first cycle and to direct permeate water in second cycle; and at least a second output valve to direct permeate water in first cycle and to direct discard water in second cycle. The post-purification unit also comprises at least a mineral cartridge, a TDS sensor; and optionally a germicidal UV cartridge.

In an embodiment, optionally, the purified water optionally passes through a mineral cartridge for fortifying the purified water with one or more minerals. The purified water also passes through a germicidal UV cartridge. The purified water is stored in a storage tank while the waste/discard water is discarded into drain or can be repurposed for household use such as mopping, gardening etc.

The water purification system may also comprise one or more pumps to push water within and/or between the pre-purification unit, purification unit, and the post-purification unit.

The water purification system is capable of adjusting the TDS of the purified water to within acceptable limits, such as for drinking, which can be less than 500 ppm, preferably less than 300 ppm, more preferably less than 250 ppm, and most preferably less than 150 ppm. In an embodiment, the water purification system reduces the TDS by upto 90% or more, depending upon input water parameters.

The present invention also provides a method of purifying water, the method comprising: selecting via an interface required parameters of purified water in a water purifying system; allowing input water to enter the system as substantially described herein; and collecting purified water.

In an exemplary embodiment, the system can generate permeate water at a rate of 25 L/hr @ 90% recovery rate.

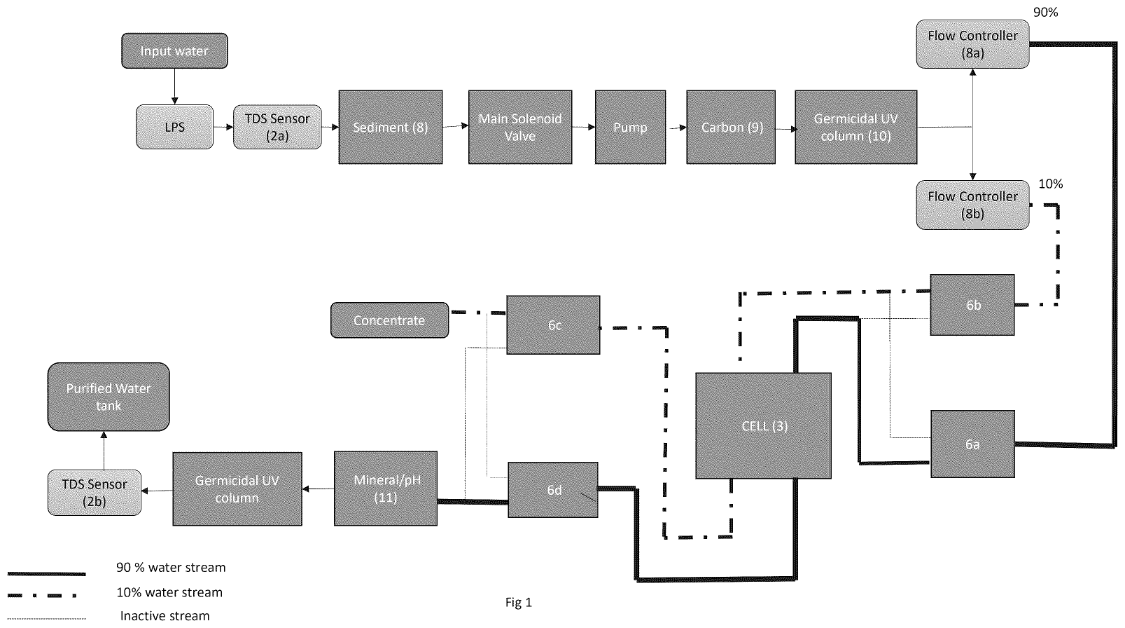

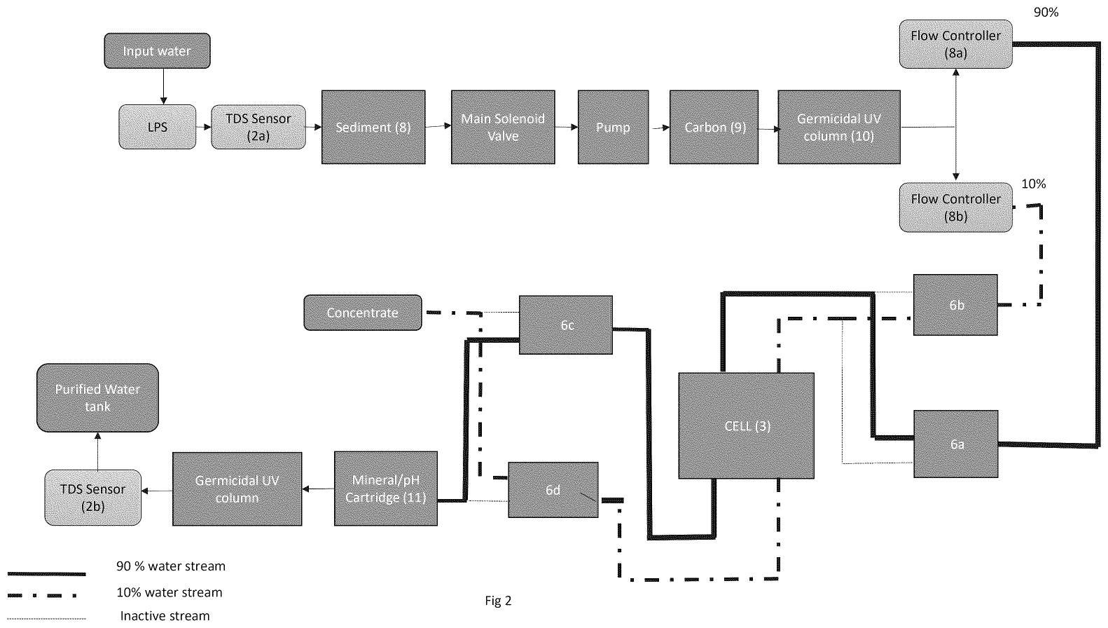

In a particular exemplification of the water purification system of the present invention, as seen in FIG. 1 and FIG. 2, there is provided a schematic of the water purification system (1) and the water flow in the purification process in the first cycle and second cycle respectively. The system (1) comprises a low-pressure switch (LPS) to detect input water pressure. The function of LPS is primarily to switch off the system (1) when input water pressure is low so as to avoid damage to the components of the system (1). The TDS content of the input water is detected by a first TDS sensor (2a). Based on the TDS content of input water the desired TDS content of the output/purified water, the microcontroller (7) (not shown) selects appropriate purification cycle parameters. The input water is next filtered sequentially by the sediment cartridge (8), followed by filtration by activated carbon cartridge (9) and thereafter the germicidal UV cartridge (10). The pre-filtered input water is divided into two parallel flows by a first flow controller (8a) and a second flow controller (8b). The cell (3) comprised in the purification unit of the system (1) comprises a plurality of cation (4a) and anion (4b) exchange membranes arranged in alternate repeating manner with a spacer in between. The space/area between two adjacent membranes is designated as “compartment” (not shown). The membranes (4) are sandwiched between electrodes (5), which are preferably carbon based. Each of the compartments can directly be fed with pre-filtered input water from the first input valve (6a) and second input valve (6b). Each of the compartments can also be drained out via output valve for discard water (6c) and output valve for purified water (6d).

### Cycle 1

In cycle 1 of water purification, as shown in FIG. 1, the first flow controller (8a) directs 90% of the pre-filtered input water to a first input valve (6a) via an input port (solid line) while the second flow controller (8b) directs remainder 10% of the pre-filtered input water to a second input valve (6b) via an input port (dashed line). The input valves (6a, 6b) in this case are solenoid valves with 1 input port and 2 output ports.

The 90% of the pre-filtered water enters a plurality of first set of alternate compartments of the cell (3) designated as first compartment for reference via a first outlet port of the first input valve (6a). Concurrently, 10% of the pre-filtered water enters a plurality of second set of alternate compartments of the cell (3) designated as second compartment for reference via a first outlet port of the second input valve (6b) (dashed line). It is to be noted that no two adjacent compartments are both first compartment or second compartment. It is understood that the two outermost compartments would be flanked on one side by electrode assembly), and not an ion selective membrane.

Output valve (6c) is also open during the first cycle and collects discard water from the plurality of second compartments via first outlet port (dashed line). Output valve (6d) is also open during the first cycle and collects permeate water from the plurality of first compartments via first outlet port (solid line). The permeate water subsequently passes through the mineralization/pH cartridge (11) and germicidal UV cartridge for storage and subsequent use. The output valves (6c, 6d) in this case are solenoid valves with 1 input port and 2 output ports.

### Cycle 2

In cycle 2 of water purification, as shown in FIG. 2, when the polarity of the electrodes (5) is reversed, 90% of the pre-filtered water now enters the plurality of designated second compartments via the second outlet port of the first input valve (6a) (solid line). Concurrently, 10% of the pre-filtered water enters the plurality of designated first compartments via the second outlet port of the second input valve (6b) (dashed line).

Output valve (6c) which in the first cycle was collecting discard water via the first outlet port, after a certain time delay post initiation of the second cycle (such as 10-120 seconds), starts collecting permeate water from the plurality of the designated second compartments via second outlet port (solid line). The permeate water subsequently passes through the mineralization/pH cartridge and germicidal UV cartridge for storage and subsequent use. Outlet port (6d), which in the first cycle was collecting permeate water via the first outlet port, without any delay post initiation of the second cycle, starts collecting discard water from the plurality of the designated first compartments via second outlet port (dashed line).

It is understood that when reverting to cycle 1 after cycle 2, the time delay will be introduced in outlet valve (6d) and no delay in opening of outlet valve (6c).

A user, via an interface, can select the quality of desired purified water in terms of TDS levels, mineral fortification, and pH level prior to operation of the system. The microcontroller of the system can subsequently select operational parameters to provide the desired purified water.

### Advantages of the Present Invention

The water purification system of the present invention is capable of providing purified water with upto 90% recovery.

The water purification system of the present invention is capable of fortifying purified water with one or more essential minerals as per requirement.

The water purification system of the present invention is capable of providing purified water within consistent parameters based on a wide range of input water parameters.

The water purification system of the present invention is capable of providing purified water with varying TDS levels as per requirement.

The water purification system of the present invention is capable of autonomously adjusting purification parameters such as, but not limited to cycle duration, percent amount of water entering the cell compartments to achieve desired purified water quality based on input water quality.

The dual purification cycle of the water purification system of the present invention avoids osmotic flow (back diffusion of ions) from waste/discard water to purified water within the cell compartments.

The water purification system of the present invention can undergo larger number of purification cycles and is low maintenance.

1. A water purification system (1) comprising:
a. at least a sensor (2);
b. a cell (3) comprising a plurality of selective ion exchange membranes (4) located between at least two electrodes (5);
c. at least a valve (6) to control water flow; and
d. at least a microcontroller module (7) to modulate at least the current or voltage in the cell electrodes (5).

2. The system (1) as claimed in claim 1, further comprising at least one of a sediment cartridge (8), activated carbon cartridge (9), a germicidal UV cartridge (10), and at least a mineral cartridge (11).

3. The system (1) as claimed in claim 1, wherein at least a first sensor (2a) detects total dissolved solids in input water; and at least a second sensor (2b) detects total dissolved solids in permeate water.

4. The system (1) as claimed in claim 1, wherein said at least a microcontroller (7) modulates the input current or voltage of the cell electrodes (5).

5. The system (1) as claimed in claim 1, wherein said system (1) employs dual cycle water purification comprising a first cycle and a second cycle.

6. The system (1) as claimed in claim 5, wherein first cycle and second cycle run duration time can be same or different.

7. The system (1) as claimed in claim 5, wherein the polarity of the electrodes (5) in first cycle and second cycle are reversed.

8. The system (1) as claimed in claim 1, wherein the cell (3) comprises at least a cation exchange membrane (4a) and at least an anion exchange membrane (4b).

9. The system (1) as claimed in claim 8, wherein no two cation or anion exchange membranes are adjacent to each other.

10. The system (1) as claimed in claim 1, comprising a first input value (6a), and a second input value (6b) to direct input water into at least a first and second compartment respectively of the cell (3).

11. The system (1) as claimed in claim 1, comprising at least a flow controller (8), in particular, a first flow controller (8a) and a second flow controller (8b).

12. The system (1) as claimed in claim 5, wherein in first cycle, for a time duration, the first flow controller (8a) directs upto 90% of input water through first input valve (6a) into at least a plurality of first compartments of the cell (3), and the second flow controller (8b) directs at least 10% of input water through second input valve (6b) into at least a plurality of second compartments of the cell (3); and
in second cycle, for a time duration, the first flow controller (8a) directs upto 90% of input water through first input valve (6a) into at least the plurality of second compartments of the cell (3), and the second flow controller (8b) directs at least 10% of input water through second input valve (6b) into at least the plurality of first compartments of the cell (3).

13. The system (1) as claimed in claim 1, comprising at least a first output value (6c), and at least a second output valve (6d).

14. The system (1) as claimed in claim 13, wherein said at least first output valve (6c) directs discard water in cycle 1 and collects permeate water in cycle 2; and second output valve (6d) collects permeate water in cycle 1 and directs discard water in cycle 2.

15. The system (1) as claimed in claim 14, wherein the switching of first outlet valve (6c) in cycle 2 is delayed by a time period after initiation of cycle 2; and switching of second outlet valve (6d) is delayed for a time period after initiation of cycle 1 after cycle 2.

16. The system (1) as claimed in claim 1, wherein the system (1) is capable of maintaining output water purity parameters across a wide band of input water parameters.

17. The system (1) as claimed in claim 1, wherein said valves (6) are solenoid valves.

18. The system (1) as claimed in claim 2, wherein said mineral cartridge (11) optionally adds at least a mineral to the permeate water.

19. A method of purifying water, said method comprising:
a. selecting required parameters of purified water via a user interface of the system (1) as claimed in claim 1;
b. allowing input water to enter the system (1) as claimed in claim 1; and
c. collecting purified water.

20. The method as claimed in claim 19, wherein in a first cycle of water purification, for a first time duration, the first flow controller (8a) directs upto 90% of input water through first input valve (6a) into at least a plurality of first compartments of the cell (3), and the second flow controller (8b) directs at least 10% of input water through second input valve (6b) into at least a plurality of second compartments of the cell (3); and
output valve (6c) directs discard water from plurality of second compartments, and output valve (6d) directs permeate water from plurality of first compartments.

21. The method as claimed in claim 20, wherein in a second cycle of water purification, for a second time duration, the first flow controller (8a) directs upto 90% of input water through first input valve (6a) into at least a plurality of the second compartments of the cell (3), and the second flow controller (8b)) directs at least 10% of input water through second input valve (6b) into at least a plurality of first compartments of the cell (3); and
output valve (6c) after time delay, directs permeate water from plurality of second compartments, and output valve (6d) directs discard water from plurality of first compartments.
